(19) United States
(12) Patent Application Publication
(10) Pub. No.: US 2007/0217872 A1
(43) Pub. Date: Sep. 20, 2007

(54) Method for Removal of Material Mined Underground and Device for Carrying Out Said Method

(75) Inventor: Thomas Gross, ZELTWEG (AT)

Correspondence Address: CHAPMAN AND CUTLER, 111 WEST MONROE STREET, CHICAGO, IL, 60603, US

(73) Assignee: Voest-Alpine Bergtechnik Gesellschaft m.b.h., Zeltweg (AT)

(21) Appl. No.: 10/581,989

(22) PCT Filed: Nov. 30, 2004
(86) PCT No.: PCT/AT04/00419

§ 371 Date: Feb. 26, 2007

(30) Foreign Application Priority Data
Dec. 10, 2003 (AT) A 1985/2003

(51) Int. Cl. B60P 1/44

(52) U.S. Cl. 406/40

(57) ABSTRACT

In a method for the haulage of subsurface-mined material with at least one vehicle featuring a travel drive, at least two vehicles are used in the roadway section between the heading face and a continuously extended haulage means, wherein at least one material transfer from one vehicle to another vehicle takes place between the heading face and the transfer of the material to the haulage means.

The invention pertains to a method and an arrangement for the haulage of subsurface-mined material.

There exist various methods for the haulage in subsurface mining. It is known, in particular, to initially create driving roadways, on which the desired material is obtained laterally of the roadway. In addition to so-called “longwall mining,” a method of this type has also become known, for example, as a “room and pillar” method, in which the material is mined from rooms and pillars are respectively left standing in order to support the roofs. Subsurface haulage means, for example, in the form of extendible conveyor belts are usually arranged in the roadway. It is also known to realize such subsurface haulage means in the form of overhead conveyors or haulage means that are suspended from the roof. If it is intended to employ a “room and pillar” method, it is therefore common practice to drive a roadway, the width of which essentially corresponds to the width of the tunneling machine, wherein further mining is then carried out laterally of this roadway. In order to allow an efficient haulage of the materials mined during the driving of the roadway, it is known to utilize so-called “shuttle” vehicles that transport material back and forth between the tunneling machine and therefore the heading face and a stationary haulage device that is arranged in the roadway further toward the rear. In this respect, we refer, for example, to US 2 282 704 A. However, a passing option for such vehicles is not provided in the region of this roadway such that two vehicles traveling in opposite directions cannot pass or cross one another and the vehicles therefore need to travel the distance between the heading face and the stationary haulage means as fast as possible, namely also in relatively tight curves. If the vehicles need to travel, in particular, longer distances between the material pick-up directly behind the tunneling machine and the transfer to the stationary haulage means in the roadway, the transport with such shuttle vehicles represents the step of the mining process that defines the speed.

The invention is based on the objective of improving the haulage capacity in the initially cited driving of roadways, namely also if the distances between the material pick-up and the material transfer are relatively long, and to largely eliminate standstill times, wherein the invention also aims to develop interchangeable vehicles that can be used very flexibly and are able, in particular, to negotiate curves very well.

According to the inventive method, this objective is essentially attained in that at least two vehicles that respectively feature a travel drive are used in the roadway section between the heading face and haulage means that are continuously extended, wherein at least one material transfer from one vehicle to another vehicle takes place between the heading face and the transfer of the material to the haulage means. Since at least two vehicles are used in the roadway section between the heading face and a haulage means that is continuously extended, it is possible to increase the flexibility by utilizing several vehicles of preferably identical design in order to minimize the required time. To this end, it is merely required to carry out the method such that one vehicle completely transfers the respective material picked up near the heading face to another vehicle such that this vehicle no longer has to travel the entire distance between the heading face or the tunneling machine and the stationary haulage means. Such an optimization merely requires that the method is carried out such that the transfer of the material from one vehicle to another vehicle requires less time than that required for traveling the respective additional distance, i.e., a single or multiple transfer to succeeding vehicles respectively creates free capacities that also ensure the continuous haulage of the material mined by the tunneling machine if the stationary haulage means is not extended as far as the heading face. According to the invention, the method is carried out such that at least one material transfer from one vehicle to another vehicle takes place between the heading face and the transfer of the material to the haulage means.

The realization of this method requires correspondingly adapted vehicles, wherein these vehicles not only need to be highly flexible and able to negotiate curves very well, but also fulfill the constructive prerequisites for the transfer of the material from one vehicle to the succeeding vehicle. It is particularly advantageous to realize the inventive arrangement for the haulage of subsurface-mined material in such a way that at least two vehicles featuring a travel drive are provided, wherein material can be respectively loaded on said vehicles with a first haulage means and material is transferred to another haulage means from said vehicles, and wherein the vehicles feature linear conveying devices, e.g., conveyor belts, and at least one linear conveying device of each vehicle is arranged on the vehicle frame such that it can be raised and lowered, as well as displaced in the conveying direction. The at least two vehicles may be realized identically in this embodiment such that they can be flexibly interchanged, wherein the linear conveying devices arranged on the vehicle itself make it possible to load the vehicle as quickly and as completely as possible, namely even if the transfer takes place on one end of the vehicle only. Consequently, the material transferred onto the end of the vehicle or above the end of the vehicle is moved into a position by the conveying device that lies near the front end thereof such that new material can be continuously loaded onto the rear end. With respect to the material transfer, it is particularly advantageous to transfer the material as far as possible from the rear end of the vehicle, particularly near the center of the conveying means, in order to achieve a particularly advantageous broken material contour and to allow the haulage of large quantities with small-size vehicles. In order to enable each of these vehicles to transfer the picked-up material to a succeeding vehicle, the arrangement according to the invention is realized such that at least one linear conveying device is arranged on the vehicle frame of each vehicle in such a way that it can be raised and lowered as well as displaced in the conveying direction. Such a displacement of the conveying device in the longitudinal direction of the vehicle and the simultaneous raising of the drop-off end make it possible to quickly transfer the material to a succeeding vehicle such that the vehicle emptied in this fashion can travel back to the heading face. In the preferred embodiment of the inventive vehicle, it is by no means necessary to realize the entire linear conveying device such that it can be displaced in the longitudinal direction of the vehicle. On the contrary, it suffices to design the conveying device such that a conveying means realized separately of the linear conveying device can be retracted into the vehicle frame underneath the linear conveying device and raised in an extended position.

A very flexible design and, in particular, an adequate drop-off characteristic can be achieved if the linear conveying devices of the vehicle feature at least one articulated axle that extends transverse to the conveying direction. In this case, the conveying devices are advantageously designed such that the sections of the linear conveying devices of each vehicle are interconnected in an articulated fashion, as well as to separate actuating drives for raising and lowering the sections. The ability to longitudinally displace raisable sections of this type can be achieved in a particularly simple fashion if at least one section of the linear conveying device is realized in the form of a sled or connected to a sled that can be displaced in the longitudinal direction of the vehicle.

The ability to negotiate curves particularly well can be ensured in vehicles of this type by realizing the linear conveying device and, if applicable, the additional separate conveying means such that they can be retracted into a position that essentially lies within the outline of the vehicle in a top view thereof.

This means that, in principle, two types of vehicles are provided that can be interchanged and may also be simply realized identically in order to simplify the maintenance and the stock keeping of spare parts. The first of these vehicle types features a second, extendible conveying device underneath a chain conveyor that is essentially non-displaceable in the longitudinal direction of the vehicle, wherein this second conveying device can be adjusted with respect to its height and extended in a cantilever fashion for the transfer of the material from one vehicle to another vehicle. In the second vehicle type, the entire conveyor is displaced in the longitudinal direction of the machine for the material transfer and preferably realized in an articulated fashion in order to achieve the corresponding transfer height.

Such a choice of identical vehicles also provides the additional advantage that the vehicles can be randomly interchanged and, in particular, longer sections between the heading face and the stationary haulage means can be covered by using a corresponding number of vehicles in order to optimize the overall time required for the haulage. Consequently, the optimization is realized by selecting a suitable number of transport vehicles, as well as the suitable transfer point in the roadway section to be traveled between the heading face and the stationary haulage device.

The invention is described in greater detail below with reference to one embodiment that is schematically illustrated in the drawings. In these drawings,

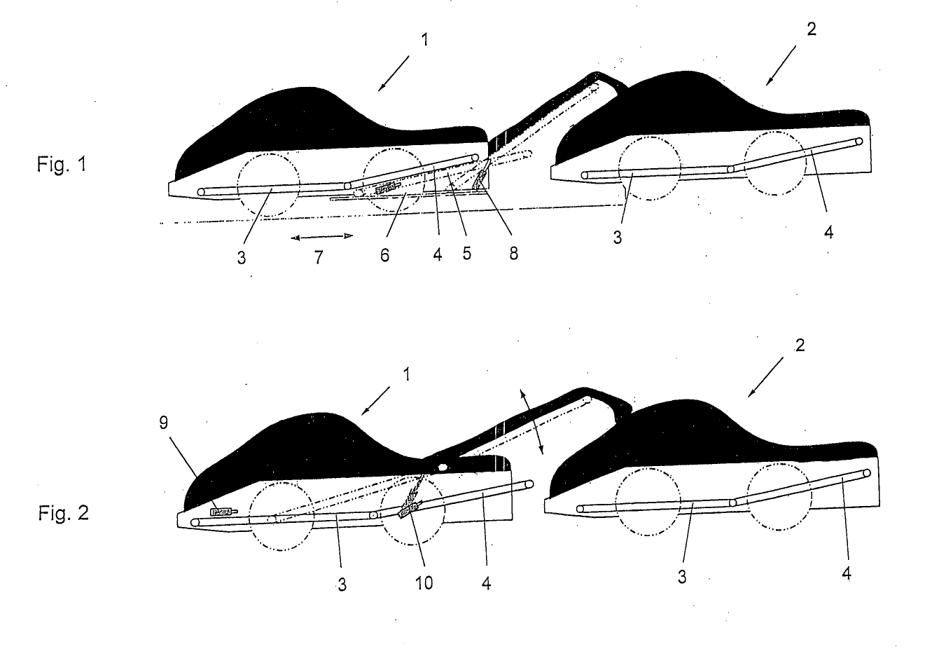

FIG. 1 shows a schematic side view of a first type of vehicle suitable for carrying out the method according to the invention,

FIG. 2 shows a correspondingly modified embodiment and

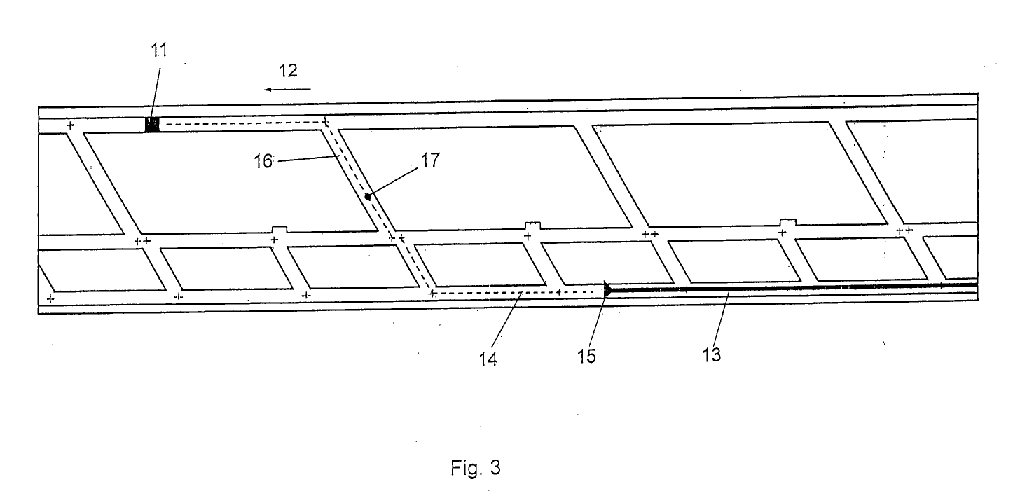

FIG. 3 shows the course of the roadway and the transfer point in the roadway between two such vehicles that cover the distance between the heading face and the stationary haulage means.

FIG. 1 shows two vehicles 1 and 2 that respectively feature linear conveying means 3 and 4. These two linear conveying means 3 and 4 may be interconnected rigidly or in an articulated fashion. An additional linear conveying means 5 is arranged underneath the front section of the conveying means. This additional linear conveying means 5 can be displaced in the longitudinal direction of the vehicle by means of a slide track 6 as indicated with the double arrow 7 and raised accordingly in the overhanging position by means of a piston-cylinder unit 8 so as to achieve a corresponding drop-off parabola during the transfer to a succeeding vehicle 2.

In the embodiment according to FIG. 2, the separate additional conveying device 5 is eliminated. In this case, the two sections 3 and 4 of the linear conveying means are interconnected in an articulated fashion and displaced in the longitudinal direction of the machine by means of a hydraulic piston-cylinder unit 9, wherein said sections can be raised accordingly in the transfer position by means of the hydraulic piston-cylinder unit 10 in order to achieve an optimal transfer to the succeeding vehicle 2.

The reference symbol 11 in FIG. 3 schematically indicates the position of the tunneling machine for driving the roadway in the direction of the arrow 12. The stationary haulage means is schematically indicated with the reference symbol 13 and situated in another, already driven roadway 14. The extension of this haulage means 13 ends at the position 15 such that the distance between the tunneling machine 11 and therefore the heading face and the end of the extension 15 needs to be covered with corresponding vehicles as they are illustrated in FIGS. 1 and 2. For this purpose, the vehicles initially travel opposite to the direction of the arrow 12 and subsequently to the already driven roadway 14 containing the haulage means 13 via a crossway 16. Since this distance is relatively long, two vehicles of the type illustrated in FIG. 1 and FIG. 2 are used for covering this section, wherein the transfer point is situated at the position 17 in the crossway 16. Consequently, a first vehicle 1 receives the material mined by the tunneling machine 11 and transports this material to the transfer point 17 where it is transferred to a second vehicle 2 that subsequently transfers the material to the haulage means at the position 15. The first vehicle can travel forward to the meanwhile additionally advanced tunneling machine 11 in order to pick up and haul new material while the second vehicle travels the distance from the transfer point 17 to the stationary haulage means 15.

1. A method for haulage of subsurface-mined material using at least two similar vehicles, each of said similar vehicles comprising vehicle a travel drive, comprising the steps of
moving said at least two similar vehicles in a roadway section between a heading face and a continuously extended haulage means, and
conducting at least one material transfer from a first of said similar vehicles to a second of said similar vehicles between the heading face and a transfer of the material to the haulage means.

2. A method according to claim 1, wherein
said at least two similar vehicles (1, 2) comprise linear conveying devices (3, 4), and wherein
at least one linear conveying device of each vehicle is arranged on a vehicle frame so as to be raised and lowered, and to be displaceable in a conveying direction.

3. A method according to claim 2, wherein said linear conveying devices of the vehicles comprise at least one articulated axle that extends transversely to the conveying direction.

4. A method according to claim 2, wherein sections of said linear conveying device of each vehicle are interconnected in an articulated fashion and are connected to separate actuating drives for raising and lowering the sections.

5. A method according to claim 2, wherein at least one section of said linear conveying device is in the form of a sled adapted to be displaceable in a longitudinal direction of said vehicle.

6. A method according to claim 2, wherein a conveying means (5) realized separately of said linear conveying device is arranged underneath said linear conveying device so as to be retractable into said vehicle frame and raised into an extended position.

7. A method according to claim 2, wherein said linear conveying device is arranged so as to be retractable into a position that essentially lies within an outline of said vehicle in a top view thereof.

8. A method according to claim 2, wherein said linear conveying devices (3, 4) are conveyor belts.

9. A method according to claim 2, wherein at least one section of said linear conveying device is connected to a sled adapted to be displaceable in a longitudinal direction of said vehicle.

10. A method according to claim 6, wherein said linear conveying device and said additional separate conveying means (5) are both arranged so as to be retractable into a position that essentially lies within an outline of said vehicle in a top view thereof.

11. A method according to claim 3, wherein sections of said linear conveying device of each vehicle are interconnected in an articulated fashion and are connected to separate actuating drives for raising and lowering the sections.

12. A method according to claim 3, wherein at least one section of said linear conveying device is in the form of a sled adapted to be displaceable in a longitudinal direction of said vehicle.

13. A method according to claim 4, wherein at least one section of said linear conveying device is in the form of a sled adapted to be displaceable in a longitudinal direction of said vehicle.

14. A method according to claim 3, wherein a conveying means (5) realized separately of said linear conveying device is arranged underneath said linear conveying device so as to be retractable into said vehicle frame and raised into an extended position.

15. A method according to claim 4, wherein a conveying means (5) realized separately of said linear conveying device is arranged underneath said linear conveying device so as to be retractable into said vehicle frame and raised into an extended position.

16. A method according to claim 5, wherein a conveying means (5) realized separately of said linear conveying device is arranged underneath said linear conveying device so as to be retractable into said vehicle frame and raised into an extended position.

17. A method according to claim 3, wherein said linear conveying device is arranged so as to be retractable into a position that essentially lies within an outline of said vehicle in a top view thereof.

18. A method according to claim 4, wherein said linear conveying device is arranged so as to be retractable into a position that essentially lies within an outline of said vehicle in a top view thereof.

19. A method according to claim 5, wherein said linear conveying device is arranged so as to be retractable into a position that essentially lies within an outline of said vehicle in a top view thereof.

20. A method according to claim 6, wherein said linear conveying device is arranged so as to be retractable into a position that essentially lies within an outline of said vehicle in a top view thereof.
